(19) United States
(12) Patent Application Publication
(10) Pub. No.: US 2013/0034637 A1
(43) Pub. Date: Feb. 7, 2013

(54) SMOKING METHOD OF DUCK MEAT WITH WINE

(71) Applicant: Woo Jin LEE, Daejeon (KR)

(72) Inventor: Woo Jin LEE, Daejeon (KR)

(21) Appl. No.: 13/204,628

(22) Filed: Aug. 5, 2011

(51) Int. Cl. A23L 1/318; A23L 1/315

(52) U.S. Cl. 426/281

(57) ABSTRACT

A smoking method of duck meat with wine includes making salt water by blending water, wine and curing agent in a massage tumbler. A container made up of a double jacket includes a partition inside making it available to hold inside temperature −10° C.-10° C. Wine sauce is placed into the tumbler with mixing ingredients for about 15-30 min at temperature of −2-25° C. Duck meat (the weight range of meat which is without neck, tail, foot, bone and organs is 2.2-3.8 kg) and interfusing salt water containing wine are placed into the meat by 4-15 rpm spinning massage and soakage for 100-210 min. The massage tumbler is cooled down by injecting refrigerant into the jacket. The salted duck meat is roasted at a temperature of 80-250° C. for 70-180 min in a kiln with charcoal or an oak.

### RELATED APPLICATION

In reference with the present invention, Korea patent public gazette no. 10-2001-0099158, a method of making spam, ham and sausage using low fat high nutrition duck and sulfur duck is introduced. In addition, the manufacturing method of smoked duck meat is shown in patent registration gazette no. 10-0481164, the procedure of processing and cleaning duck meat, salting duck meat with salt water from a group of salt water; Kashima, pear, grape extract, smoking, heating, cooling, vacuum packing and shipping is marked as Smoking method of Duck meat in patent registration gazette no. 10-0976354.

As stated above, previous inventions were to improve the function for health food. However, a new method of salted duck food, reducing fishy taste of meat and softening salty taste of its own and making its meat less tough so that people could savor the meat deeply, is required for duck food industry to advance to staple diet.

### BACKGROUND OF THE INVENTION

The present invention primarily relates to smoked duck meat. Duck meat is a good source for Fe, P, Vitamin B, and has more unsaturated fat content than beef or pork, and lastly, it is good for weight control diet, a convalescence patient and old people who rarely have physical activity because it is low calorie. That is to say, unlike other meat, duck meat is alkalescence, which fits to human body. Thus, due to its rich nutriment like Na, Ca, lecithin and Selenium, duck meat alleviates stroke, sclerosis of the arteries, high blood pressure by reducing cholesterol rate and it helps prevent osteoporosis, diabetes, neuralgia and cancer.

Recently, duck meat is riding a wave of industrial interest and its consumption increased to 15% of that of chicken as its function of antidote, curing circulatory disease and its relation with environment friendly agriculture are acknowledged and the number of duck farm increases.

However, while there are various ways of cooking chicken, yet few method for duck have been studied. To be specific, despite it has recently gained awareness by public, its popularity is growing sharply, and it is commercialized being packed apart according to its part; duck brisket. In general, duck meat is treated either packed for roast meat or like health food like chicken soup.

### SUMMARY THE INVENTION

An object of the present invention is to provide a method of smoked wine duck meat. In detail, it is to provide a smoked wine duck meat, which is odorless and of which the meat is soft, suitable for consumers' taste by interfusing salt water containing wine into duck meat by spinning and soakage in a tumbler and roasting in a kiln more than at 200° C.

This invention is about smoking method of duck meat with wine, comprising step 1 (S10); making salt water by blending water, wine and curing agent in a massage tumbler, a container made up of double jacket including a partition inside making it available to hold inside temperature −10° C.-10° C., step 2 (S20); putting wine sauce into the tumbler and mixing ingredients for about 15-30 min at temperature of −2-25° C., step 3 (S30); putting duck meat (the weight range of meat which is without neck, tail, foot, bone and organs is 2.2-3.8 kg) and interfusing salt water containing wine into the meat by 4-15 rpm spinning massage and soakage for 100-210 min, step 4 (S40); cooling down the massage tumbler by injecting refrigerant into the jacket, step 5 (S50); roasting salted duck meat at temperature of 80-250° C. for 70-180 min in a kiln with charcoal or an oak. In addition, this invention is to offer the recipe of smoked wine duck meat. Moreover, since this invention removes the odor of duck's own and strengthen the soft and juicy taste, it could provide the consumer a suitable dish for their changing taste.

### BRIEF DESCRIPTION OF THE DRAWING

FIG. 1 is a flow diagram showing smoking method of duck meat with wine.

### DESCRIPTION OF THE PREFERRED EMBODIMENTS

The invention's goal is to solve the problem above and provide product beneficial to body and tasty.

A smoking method for this goal, smokes wine salted duck meat, comprising step 1 (S10); making salt water by blending water, wine and curing agent in a massage tumbler, a container made up of double jacket including a partition inside making it available to hold inside temperature −10° C.-+10° C., step 2 (S20); putting wine sauce into the tumbler and mixing ingredients for about 15-30 min at temperature of −2-25° C., step 3 (S30); putting duck meat (the weight range of meat which is without neck, tail, foot, bone and organs is 2.2-3.8 kg) and interfusing salt water containing wine into the meat by 4-15 rpm spinning massage and soakage for 100-210 min, step 4 (S40); cooling down the massage tumbler by injecting refrigerant into the jacket, step 5 (S50); roasting salted duck meat at temperature of 80-250° C. for 70-180 min in a kiln with charcoal or an oak, provides the method above for smoked wine duck meat.

In addition, the method is characterized as it choosingly blend white or red wine in process.

Also, salt water consists of 52% of wine sauce, 38% of regal brine mix, 5.2% of salt, 3.8% of Sodium erythorbate, 1.0% of Ereglutamineacid natrium.

And wine sauce consists of 37.32% of water, 29% of maltitol, 16% of red wine, 10% of apple mix juice, 5% of soy sauce, 5.2% of salt, 0.18% of sauce mix.

The Related examples and real case of the invention are as in the following.

The method of invention is characterized as following comprising step 1 (S10); making salt water by blending water, wine and curing agent in a massage tumbler, a container made up of double jacket including a partition inside making it available to hold inside temperature −10° C.-+10° C., step 2 (S20); putting wine sauce into the tumbler and mixing ingredients for about 15-30 min at temperature of −2-25° C., step 3 (S30); putting duck meat (the weight range of meat which is without neck, tail, foot, bone and organs is 2.2-3.8 kg) and interfusing salt water containing wine into the meat by 4-15 rpm spinning massage and soakage for 100-210 min, step 4 (S40); cooling down the massage tumbler by injecting refrigerant into the jacket, step 5 (S50); roasting salted duck meat at temperature of 80-250° C. for 70-180 min in a kiln with charcoal or an oak.

The salt water is made putting wine and other spices (salt, dextrin, ginger, onion, garlic) into water, and wine is choosingly selected between red and white.

The salt water consists of 52% of wine sauce, 38% of regal brine mix, 5.2% of salt, 3.8% of Sodium erythorbate, 1.0% of Ereglutamineacid natrium.

Especially, wine sauce consists of 37.32% of water, 29% of maltitol, 16% of red wine, 10% of apple mix juice, 5% of soy sauce, 5.2% of salt, 0.18% of sauce mix.

The regal brine mix consists of 23.79% of salt, 3.20% of Sodium Metaphosphate, 1.75% of Sodium Pyrophosphate, 1.00% of sodium carbonate, 1.44% of sodium nitrite, 0.13% of sodium nitrate, 23.00% of maltomaxstrin, 45.69% of Sodium Polyphosphate.

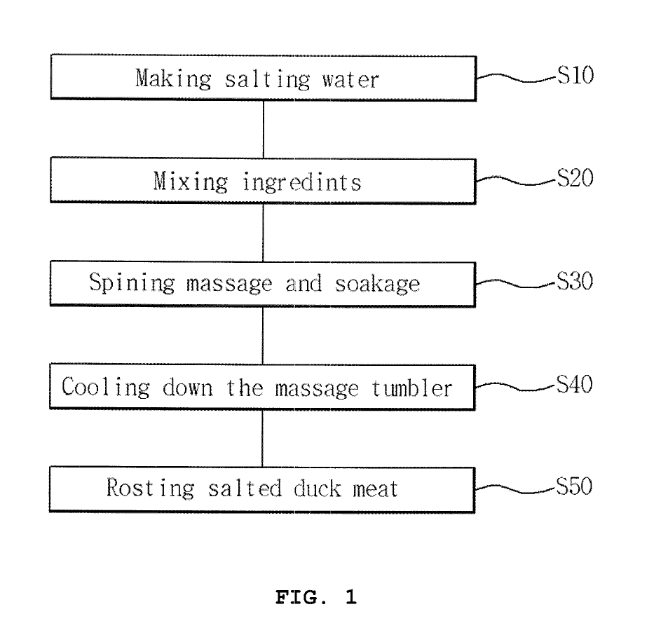

The process of manufacture is shown in following explanation and FIG. 1.

Step 1, Blending Salt Water.

In general, base material of duck meat, duck meat which excludes its bone, organ, neck, tail and feet, that range from 2.2-3.8 kg is used.

Firstly, put water and wine into double jacket tumbler, which has an inner partition, and make salt water with curing agent (S10).

Next, put wine sauce in the salt water above and blend them at temperature of −2-25° C. for 15-30 min to make a sauce which removes fishy odor and soften the meat (S20).

Step 2, Ripen

Put the duck meat into the tumbler and spin it for 4-15 rpm for about 100-210 min to interfuse duck meat with salt water (S30).

Thus, after the spinning process, the salt water would interfuse into the core of the meat, softening the meat.

After that, supply the refrigerant to the partition of the tumbler to cool down massage tumbler and put out the riped duck meat (S40).

Step 3, Roasting

Roast the salted meat at the temperature of 80-250° C. for 70-180 min using oak or charcoal.

Now, we are to explain the invention with real examples. Thus make note that the following examples do not limit a technical range of the invention.

### EXAMPLES

### Degree of Ripe and Salt Concentration of Duck Meat According to the Rev Count of Massage Tumbler

Base material of duck meat, duck meat which excludes its bone, organ, neck, tail and feet, that range from 2.2-3.8 kg is used.

### Example 1

### State of Softening and Salt Concentration

Salt water was made by blending water, wine, curing agent and other spices, and a grape concentrate, an undiluted grape solution and a red wine are used for a wine. Also, the curing agent consists of nitrite, phosphate, milk protein, Cochineal Extract, and in the vacuum tumbler (vacuums by massage using high of material falling from high after climbing up the chuck located at spinning container spinning laying at one side), the duck meat was observed at an intervals of 10 min for 200 min, and spiraled for soakage and observed its softening and salt concentration.

### Example 2

### State of Softening and Salt Concentration

The method is same as in example 1, except that the spinning ratio was 14 rpm

### Example 3

### State of Softening and Salt Concentration

The method is same as in example 1, except that the spinning ratio was 25 rpm

It is obvious that example 2 showed the highest efficiency according to a chart below. Generally, people could easily believe that increase of RPM would help ripening and salting, however, this would interfere maintenance of ripening and salting.

Example 2, the most desirable one, shows that up to 60 min, the meat was tough to eat, while after 180 min, it was over riped so that it was dry and crumbling.

As for degree of softening, spinning for 14 rpm for 60-150 min in the massage tumbler interfused salt water with wine into the meat and breaking of tissue by physical impact softened the meat. Moreover, during the roasting, heat helped maintain the softening and elevated taste with its delicate favor. Also, people could taste soft flavor of grape concentration, an undiluted grape solution, garlic, ginger.

In example 1, the meat was observed at intervals of 10 min for 200 min, and the spinning ratio for observing degree of softening and salting was 12 rpm. 1) From 10-60 min, softening was tough and the meat wasn't salted. 2) From 70 min, softening was good, but the meat wasn't salted. 3) From 80-90 min, softening was crisp and the meat wasn't salted. 4) From 100-110 min, softening was crisp and the meat wasn't salted. 5) From 120-200 min, softening was crisp and the meat was salted to middle depth.

In example 2, the meat was observed at intervals of 10 min for 200 min, and the spinning ratio for observing degree of softening and salting was 14 rpm. 1) From 10-50 min, softening was tough and the meat wasn't salted. 2) From 60-100 min, softening was good, but the meat was little salted. 3) From 110-150 min, softening was good and the meat was salted to middle depth. 4) From 150-160 min, softening was crisp and the meat wasn't salted. 5) From 120-200 min, softening was crisp and the meat was salted to middle depth.

In example 3, the meat was observed at intervals of 10 min for 200 min, and the spinning ratio for observing degree of softening and salting was 25 rpm. 1) From 10-50 min, softening was tough and the meat wasn't salted. 2) From 60-140 min, softening was tough, but the meat was salted to middle depth or little. 3) From 150-200 min, softening was crisp and the meat was salted to middle depth.

From above examples, we confirmed that from 60-150 min part of example 2 was ideal method of ripe.

As stated before, previous method was to soak or inject directly by injector or use vacuum tumbling, vacuums by massage using high of material falling from high after climbing up the chuck located at spinning container spinning laying at one side changing way of rotation, or combine soaking and massage together, which could get outstanding effect on both massage and salting, and it could salt evenly, completed through vacuum, tumbling and soaking.

Meanwhile, in example 4, we observed previous product and invention through sensory evaluation. The result of 50 panel agents is following.

1) Previous one was oatmeal outside, and fishy odor was detected at joint part of leg, and people felt fishy taste while chewing, and the last taste was fishy too, and meat was little tough and crisp.

2) Invention was also oatmeal outside, but there was no sign of fishy odor and taste during the test and agents felt wine taste, and meat was soft because in the case of invention, acidic component of wine interacts with alkalic component of fishy odor waling down the odor.

Moreover, in invented method, we could roast duck at direct fire to elevate its taste. The standard for raw material duck meat is 2.2 kg-3.8 kg and neck and tail could be removed unless sebaceous glands are not removed. In the roasting procedure, the temperature should remain 80-250° C. to avoid blackening of skin. The skin should be remained and in the process, spin the meat or circulate the air to melt fat and roast the meat to its core. Also it could be used as a suitable ingredient for smoking and oak sawdust or charcoal should be used to 45-60 or direct fire roasting.

The above explanation is stated with examples. However, unless it's not got out of from the stated range or idea of invention of range of claim, things could bare multiple convert or change.

The invention is to elevate value of duck for favorite food, and supply smoked duck meat suited for changing taste of consumer by removing unnecessary fat component and increase unsaturated fatty acid and improving softening and odor of duck's own.

What is claimed is:

1. Smoking method of duck meat with wine comprising step 1 (S10) making salt water by blending water, wine and curing agent in a massage tumbler, a container made up of double jacket including a partition inside making it available to hold inside temperature −10° C.-10° C.; step 2 (S20) putting wine sauce into the tumbler and mixing ingredients for about 15-30 min at temperature of −2-25° C.; step 3 (S30) putting duck meat and interfusing salt water containing wine into the meat by 4-15 rpm spinning massage and soakage for 100-210 min; step 4 (S40) cooling down the massage tumbler by injecting refrigerant into the jacket; step 5 (S50) roasting salted duck meat at temperature of 80-250° C. for 70-180 min in a kiln with charcoal or an oak.

2. Smoking method of duck meat with wine according to claim 1, the method of making wine ripen smoked duck meat characterized with its blending red or white wine choosingly.

3. Smoking method of duck meat with wine according to claim 1, the feature that the salt water consists of 52% of wine sauce, 38% of regal brine mix, 5.2% of salt, 3.8% of Sodium erythorbate, 1.0% of Ereglutamineacid natrium.

4. Smoking method of duck meat with wine according to claim 3, the feature that the wine sauce consists of 37.32% of water, 29% of maltitol, 16% of red wine, 10% of apple mix juice, 5% of soy sauce, 5.2% of salt, 0.18% of sauce mix.
